(19) United States
(12) Patent Application Publication
(10) Pub. No.: US 2014/0181741 A1
(43) Pub. Date: Jun. 26, 2014

(54) DISCREETLY DISPLAYING CONTEXTUALLY RELEVANT INFORMATION

(71) Applicant: MICROSOFT CORPORATION, Redmond, WA (US)

(72) Inventors: Johnson Apacible, Mercer Island, WA (US); Tim Paek, Sammamish, WA (US); Allen Herring, Sammamish, WA (US); Mark J. Encarnación, Issaquah, WA (US); Woon Kiat Wong, Redmond, WA (US)

(73) Assignee: MICROSOFT CORPORATION, Redmond, WA (US)

(21) Appl. No.: 13/726,237

(22) Filed: Dec. 24, 2012

(51) Int. Cl. G06F 3/0484

(52) U.S. Cl. CPC G06F 3/0484
USPC 715/810; 715/764

(57) ABSTRACT

The claimed subject matter provides a method for receiving and displaying contextually relevant information to a user. The method includes receiving automatically-updated contextually relevant information at a display device. The contextually relevant information includes information that is at least in part associated with the user. The display device then displays the contextually relevant information discreetly to the user.

### BACKGROUND

Current scheduling and/or collaboration solutions do not adequately address the various complexities of organizing and running meetings effectively. Some of the complexities include, for example, finding a meeting location, providing notifications related to the meeting, and introducing and providing status of attendees. In addition, current scheduling and/or collaboration solutions do not adequately handle operational aspects of meetings, such as note-taking, changes of time and venue, sharing of information, and keeping track of tasks.

Some scheduling solutions can be configured to provide notifications to an end-user of an upcoming meeting or other event, such as a meeting with co-workers, a doctor's appointment, a television show, etc. For example, a mobile computing device (also referred to herein as “mobile device”), such as a smart phone, can be configured to communicate with a calendar service to retrieve calendaring information and provide visual and/or audible notifications of upcoming events. However, if the mobile device is in the user's pocket or purse, for example, a visual notification will not be noticed. An audible notification can similarly be ineffective if the mobile device has been configured in silent mode or the volume has been turned down to avoid disruption. In addition, mobile devices are frequently placed in silent or low volume mode because an audible notification can be an annoying and jarring distraction, particularly when the user is engaged in a meeting or conversation. Further distraction is caused if the user takes the device out of the pocket, purse, or other receptacle to silence the audible notification and/or look at a corresponding visual notification. Accordingly, instead of the scheduling solution being a useful aid to the user, as intended, it can instead become, at least in some respects, a distraction.

Moreover, a visual notification of an upcoming event will typically provide very limited information, such as an event time, location, subject and nothing more. Additional information, such as a list of meeting participants, may be available, but the user is typically required to navigate through various menu options to retrieve additional relevant information.

### SUMMARY

The following presents a simplified summary of the innovation in order to provide a basic understanding of some aspects described herein. This summary is not an extensive overview of the claimed subject matter. It is intended to neither identify key or critical elements of the claimed subject matter nor delineate the scope of the subject innovation. Its sole purpose is to present some concepts of the claimed subject matter in a simplified form as a prelude to the more detailed description that is presented later.

An embodiment provides a method for receiving and displaying contextually relevant information to a user. The method includes receiving automatically-updated contextually relevant information at a display device. The contextually relevant information includes information that is at least in part associated with the user. The method further includes displaying the contextually relevant information discreetly to the user.

Another embodiment provides a display device for receiving and displaying contextually relevant information to a user. The display device includes a display module, a processing unit, and a system memory. The system memory comprises code configured to direct the processing unit to receive contextually relevant information, and cause the contextually relevant information to be displayed on the display module discreetly. The contextually relevant information includes information that is automatically derived from at least a location of the user and schedule data associated with the user;

Another embodiment provides a method for displaying contextually relevant information to a user. The method includes accessing user account information to determine a time of a scheduled event in a calendar associated with the user and automatically generating reminder information based at least in part on the determined time of the scheduled event. The method further includes receiving the automatically-generated reminder information at a display device, and displaying the automatically-generated reminder information discreetly to the user on a bi-stable display.

This Summary is provided to introduce a selection of concepts in a simplified form; these concepts are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a schematic showing an illustrative environment for a system that facilitates receiving and discreetly displaying contextually relevant information to a user in accordance with the claimed subject matter;

FIG. 2 is a schematic showing an example computing device in tethered communication with a watch having a display module in accordance with the claimed subject matter;

FIG. 3 is a schematic showing another example computing device that includes a display module capable of discreetly displaying information to the user in accordance with the claimed subject matter;

FIG. 4 is a schematic showing a display device displaying an event reminder for an upcoming scheduled event in the form of a map of the user's vicinity with an arrow pointing a direction for the user to follow to reach a location of the event in accordance with the claimed subject matter;

FIG. 5 is a schematic showing a display device displaying an event reminder for an upcoming event in the form of an icon in accordance with the claimed subject matter;

FIG. 6 is a schematic showing a display device with a touch-screen display that is displaying an example running late message automatically generated by a virtual assistant service in accordance with the claimed subject matter;

FIG. 7 is a schematic showing a display device displaying a coffee shop location as an example of automatically-updated contextually relevant information in accordance with the claimed subject matter;

FIG. 8 is a schematic showing a process flow diagram for a method implemented at a display device in accordance with the claimed subject matter;

FIG. 9 is a schematic showing another process flow diagram for a method implemented by a system comprising a virtual assistant service and a display device in accordance with the claimed subject matter; and

FIG. 10 is a schematic showing illustrative computing functionality that can be used to implement any aspect of the features shown in the foregoing drawings.

### DETAILED DESCRIPTION

The claimed subject matter is described with reference to the drawings, wherein like reference numerals are used to refer to like elements throughout. In the following description, for purposes of explanation, numerous specific details are set forth in order to provide a thorough understanding of the subject innovation. It may be evident, however, that the claimed subject matter may be practiced without these specific details. In other instances, well-known structures and devices are shown in block diagram form in order to facilitate describing the subject innovation.

As utilized herein, the terms “component,” “system,” “client” and the like are intended to refer to a computer-related entity, either hardware, software (e.g., in execution), and/or firmware, or a combination thereof. For example, a component can be a process running on a processor, an object, an executable, a program, a function, a library, a subroutine, and/or a computer or a combination of software and hardware.

By way of illustration, both an application running on a server and the server can be a component. One or more components can reside within a process and a component can be localized on one computer and/or distributed between two or more computers. The term “processor” is generally understood to refer to a hardware component, such as a processing unit of a computer system.

Furthermore, the claimed subject matter may be implemented as a method, apparatus, or article of manufacture using standard programming or engineering techniques to produce software, firmware, hardware, or any combination thereof to control a computer to implement the disclosed subject matter. The term “article of manufacture” as used herein is intended to encompass a computer program accessible from any computer-readable device, or media.

Computer-readable storage media include storage devices (e.g., hard disk, floppy disk, and magnetic strips, among others), optical disks (e.g., compact disk (CD), and digital versatile disk (DVD), among others), smart cards, and flash memory devices (e.g., card, stick, and key drive, among others). In contrast, computer-readable media (i.e., not storage media) may additionally include communication media such as transmission media for communication signals and the like.

Of course, those skilled in the art will recognize many modifications may be made to this configuration without departing from the scope or spirit of the claimed subject matter.

An example embodiment provides a system comprising a virtual assistant service and a display device that facilitate discreetly displaying automatically-updated contextually relevant (AUCR) information (also referred to herein as contextually relevant information or automatically-generated reminder information) to a user at appropriate times throughout the day. The AUCR information includes information that is at least in part associated with the user. For example, the AUCR information may include a meeting reminder that is provided with a lead-time that accounts for the user's distance from the meeting location. Some other examples of AUCR information include a weather report that is displayed when the user wakes up, a traffic report displayed when the user typically leaves to/from work, and a map of a locale displayed when a user is navigating to a destination in the locale. (Additional examples of AUCR information are described in more detail below.) Accordingly, a user can be apprised of information relevant to the context in which the user is situated in a timely manner without significant disruption to on-going activities.

Contextually relevant information may include information related to: a) the user's temporal context (e.g., time of day, time relative to a scheduled event, and/or time relative to a predictable event), b) the user's spatial context (e.g., absolute location and/or location relative to another location), c) a current user activity or history of user activities and/or d) conditions of the user's environment (e.g., weather, traffic, etc.). The contextually relevant information to be displayed can be generated at a processor local to the user (e.g., a processor in a mobile device associated with the user) or can be generated remotely from the user and received at a device having a display that is local to the user. Thus, throughout a day, via whichever device is in proximity to a user, the user may receive AUCR information.

Information that is displayed discreetly to a user is displayed in a manner and/or a location that facilitates the user quickly and easily grasping the information without requiring any socially awkward action, such as pulling a mobile device out of a pocket or purse or manually adjusting a volume setting in advance or in reaction to an audible alert. Thus, discreetly displayed information takes a relatively small amount of the user's attention and facilitates the user fluidly glancing at the displayed information without substantially disrupting or diverting attention away from any other activities that are competing for the user's attention.

Section A describes an illustrative environment of use for providing functionality for receiving AUCR information from a virtual assistant service at a display device. Section B describes illustrative methods that explain the operation of the virtual assistant service and display device. Section C describes illustrative computing functionality that can be used to implement various aspects of the display device and virtual assistant service described in Sections A and B.

### A. Illustrative Environment of Use

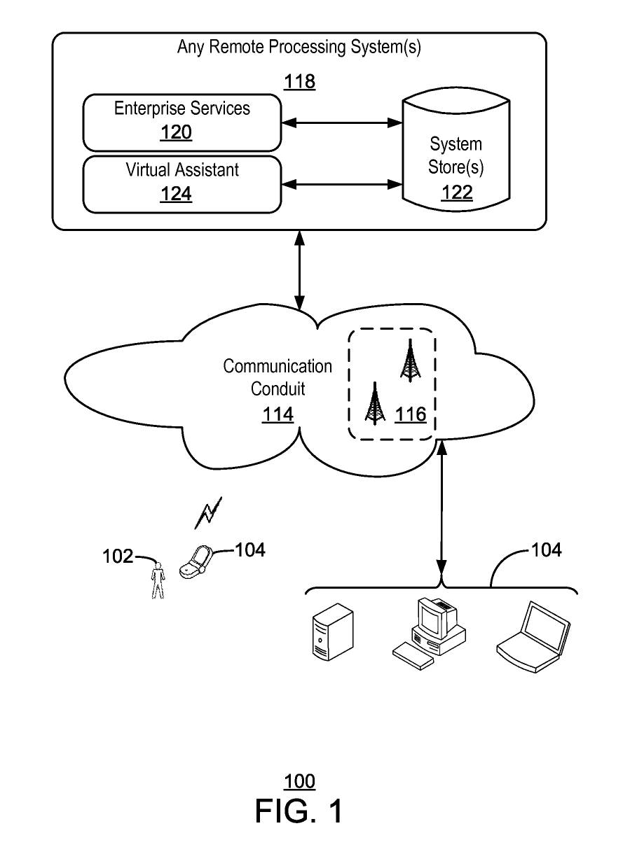

FIG. 1 is a schematic showing an illustrative environment 100 for a system that facilitates receiving and discreetly displaying contextually relevant information to a user. For example, FIG. 1 depicts an illustrative user 102 who is associated with one or more computing devices 104. The one or more computing devices may include handheld or wearable mobile devices, laptops, desktops, tablets, and the like. In certain cases, this description will state that the computing devices 104 perform certain processing functions. This statement is to be construed broadly. In some cases, the computing devices 104 can perform a function by providing logic which executes this function. Alternatively, or in addition, the computing devices 104 can perform a function by interacting with a remote entity, which performs the function on behalf of the computing devices 104.

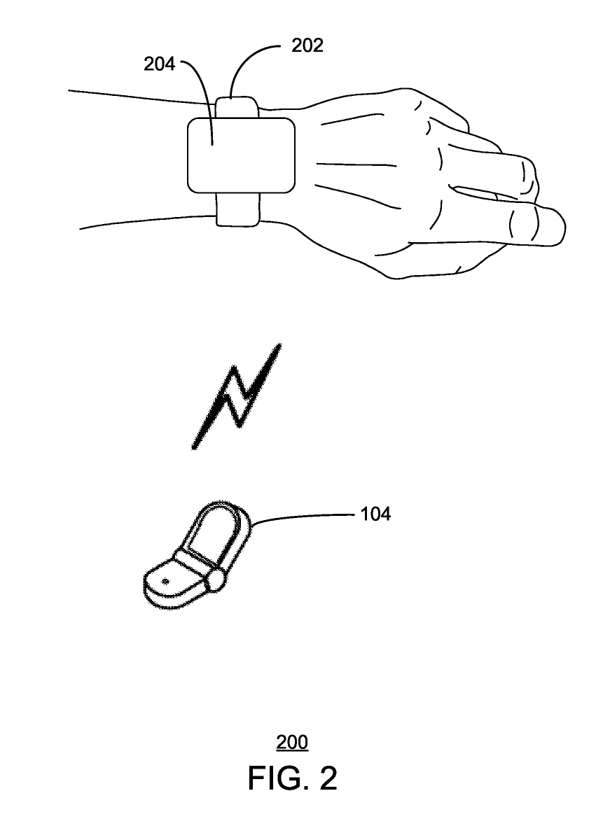

Given the above overview, the description will now advance to a more detailed description of the individual features depicted in FIG. 1. Starting with the computing devices 104, these apparatuses can be implemented in any manner and can perform any function or combination of functions. For example, the computing devices 104 can correspond to a mobile telephone device of any type (such as a smart phone), dedicated devices, such as a global positioning system (GPS) device, a book reader, a personal digital assistant (PDA), a laptop, a tablet, a netbook, game devices, portable media systems, interface modules, desktop personal computer (PC), and so on. Please note that it may be desirable to obtain user consent if collecting user data such as physical location or the like. As described in more detail with reference to FIG. 2, the computing devices 104 may be wirelessly tethered to (e.g., via a Bluetooth channel) a display device having a display module, such as a heads-up display (HUD) in a vehicle, a watch, a pair of glasses, a bracelet, a ring, or any other type of jewelry or a wearable article having a display module. The computing devices 104 may be adopted to receive a wide range of input from users, such as input via gesture from a touchscreen device or camera interface, voice input or the like.

The environment 100 also includes a communication conduit 114 for allowing the computing devices 104 to interact with any remote entity (where a “remote entity” means an entity that is remote with respect to the user 102). For example, the communication conduit 114 may allow the user 102 to use one or more of the computing devices 104 to interact with another user who is using another one or more computing devices. In addition, the communication conduit 114 may allow the user 102 to interact with any remote services. Generally speaking, the communication conduit 114 can represent a local area network, a wide area network (e.g., the Internet), or any combination thereof. The communication conduit 114 can be governed by any protocol or combination of protocols.

More specifically, the communication conduit 114 can include wireless communication infrastructure 116 as part thereof. The wireless communication infrastructure 116 represents the functionality that enables the mobile device 104 to communicate with remote entities via wireless communication. The wireless communication infrastructure 116 can encompass any of cell towers, base stations, central switching stations, satellite functionality, short-range wireless networks, and so on. The communication conduit 114 can also include hardwired links, routers, gateway functionality, name servers, etc.

The environment 100 also includes one or more remote processing systems 118, which may be collectively referred to as a cloud. The remote processing systems 118 provide services to the users. In one case, each of the remote processing systems 118 can be implemented using one or more servers and associated data stores. For instance, FIG. 1 shows that the remote processing systems 118 can include one or more enterprise services 120 and an associated system store 122. The enterprise services 120 that may be utilized in remote processing systems 118 include, but are not limited to, MICROSOFT OUTLOOK, MICROSOFT OFFICE ROUNDTABLE, and MICROSOFT OFFICE 365, which are available from Microsoft Corporation of Redmond, Washington The associated system store 122 may include basic enterprise data associated with various user accounts and accessible from the computing devices 104. The data may include information about the user 102, such as schedule information, contacts, a designated work location, a current location, organizational position, etc., and similar information about other associated users. The remote processing systems 118 can also include a virtual assistant service 124 that is also associated with the system store 122. In one embodiment, at least some of the data stored in the system store 122 including, e.g., at least some user account data, is stored at a client device, such as one or more of the computing devices 104.

In one embodiment, the virtual assistant service 142 is an enterprise service or is capable of communicating with other enterprise services 120, the system store 122, and/or one or more of the computing devices 104 in operation. The virtual assistance service 142 may also be capable of communicating with other services and data stores available on the Internet via the communication conduit 114. Accordingly, the virtual assistant service 124 can access information associated with the user 102, e.g., from the system store 122, from the computing devices 104, and/or other sources, and can automatically infer items of information that are relevant to the current context of the user 102. The virtual assistant service 124 can also deliver the AUCR pieces of information to the user 102 via the communication conduit 114. A dedicated thin client may be implemented at each of the computing devices 104 to receive the AUCR information from the virtual assistant service 124 and display it. Moreover, in one embodiment, at least a portion of the virtual assistant service 124 is executed on one of the computing devices 104 (instead of being executed on a server that is part of the remote processing systems 118) and may use the communication conduit 114 to retrieve information from other services and data stores via the communication conduit 114. Thus, data from which the AUCR information is derived may be sensed remotely (e.g., by sensors in communication with the virtual assistant service 124), locally (e.g., by sensors on the computing device 104), or a combination of remotely and locally. In addition, the data may be processed to produce the AUCR information remotely (e.g., by the virtual assistant service 124 or other services in communication with the virtual assistant service 124), locally (e.g., by the computing device 104), or a combination of remotely and locally. The ensuing description will set forth illustrative functions that the virtual assistant service 124 can perform that are germane to the operation of the computing devices 104.

FIG. 2 is a schematic showing an example computing device 104 in tethered communication with an example display device 202 having a display module 204. (Although the computing device depicted is a mobile device, this type of device is merely representative of any computing device. Moreover, the depiction of a watch as the display device 202 is representative of any display device, i.e., a device having a display module that is capable of discreetly displaying information to the user 102. For example, the display device 202 may instead be another wearable article, such as glasses, a ring, or the like.) The display module 204 may be configured not only to output information but also to receive inputs from the user 102 via physical buttons and/or soft buttons (e.g., graphical buttons displayed on a user interfaces, such as a touch-screen). Moreover, the display device 202 may be configured to display information via readily observable icons on the display module 204. To discreetly get the user's attention when the display module 204 is updated with new information, the display device 202 may be configured to flash a small light and/or gently vibrate.

In one embodiment the display module 204 is a bi-stable display. A bi-stable display can often conserve power better than a conventional display. In another embodiment, the display module 204 is capable of changing between a bi-stable display mode (e.g., when the display device 202 is in an inactive or locked mode) and a conventional display mode (e.g., when the display device 202 is in an active or un-locked mode). In yet another embodiment, only a portion of the display module 204 has bi-stable properties and the bi-stable portion is used to display the AUCR information. A bi-stable display is particularly well-suited (but not limited) to displaying content that is relatively static (e.g., text and/or images) as opposed fast-changing content (e.g., video). Accordingly, the bi-stable display (or the bi-stable portion of the display module 204) may be used (or the bi-stable mode may be entered) to display AUCR information only when the information is of a relatively static type (e.g., images and text).

In one embodiment, the computing device 104 itself is a display device that includes the display module 204, which is capable of discreetly displaying information to the user 102. Accordingly, the computing device 104 may be a wearable article (e.g., a watch or glasses), a HUD, or the like, while also being capable of interfacing directly with the communication conduit 114 without the aid of another intermediary computing device.

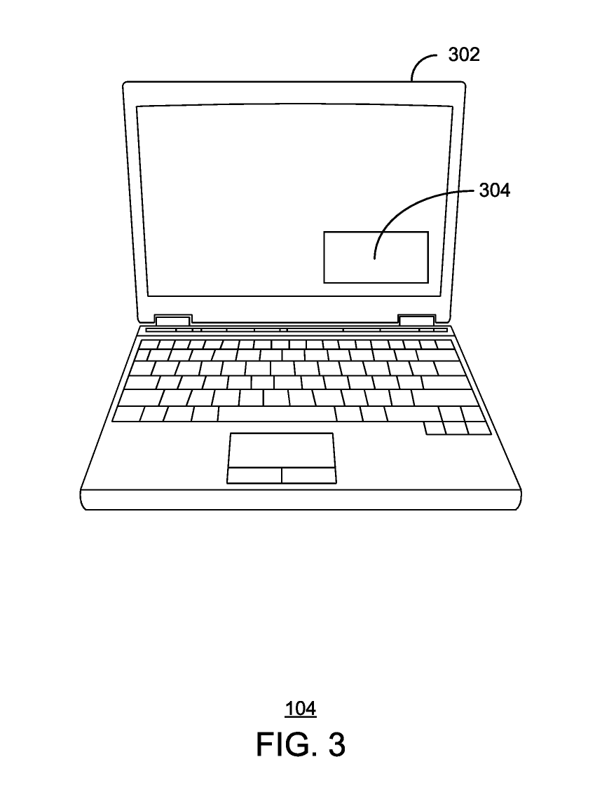

FIG. 3 is a schematic showing another example computing device 104 that includes a display module 302 capable of discreetly displaying information to the user 102. (Although the computing device depicted is a laptop, this type of device is merely representative of any computing device.) In one scenario, the user 102 is using the computing device 104 when AUCR information is received from the virtual assistant service 124. The display module 302 may be configured to display the AUCR information in a corner portion 304 of the display, as shown, thereby providing the user 102 with the AUCR information in a non-intrusive, discreet manner. Alternatively, the display module 302 may include one or more display portions that are bi-stable and may display the AUCR information on the one or more bi-stable display portions. For example, a bi-stable display portion may be smaller than and located alongside the conventional display portion. In addition, if the computing device 104 is a laptop, flip-phone, or the like, a secondary display module may be located on the back of a cover portion of the computing device 104, facing a direction opposite to that of the primary display module 302. Accordingly, the computing device 104 may be configured to display the AUCR information on the secondary display module when the cover is closed. The secondary display module may be a bi-stable display to conserve power.

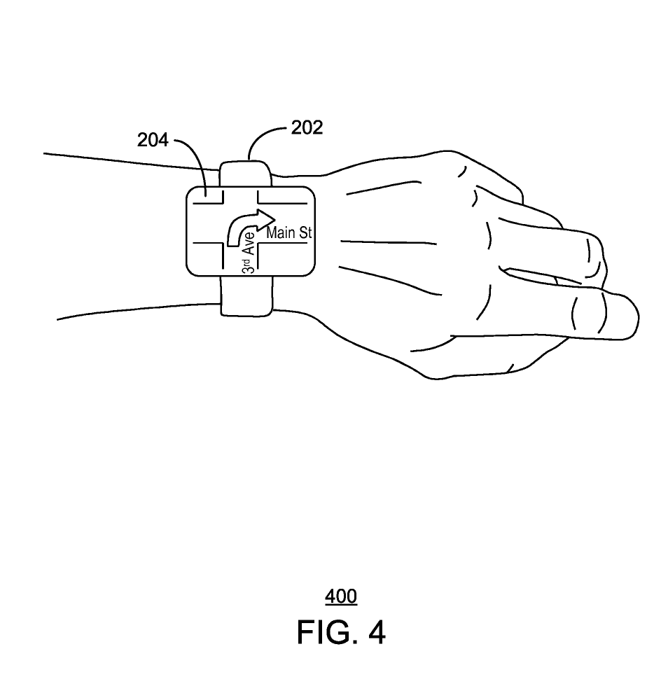

As mentioned above, the virtual assistant service 124 is a service that is available to the user 102 via the computing device 104 and the communication conduit 114 to provide the user with AUCR information. The AUCR information may be pushed to one or more computing devices 104 immediately upon being generated. Alternatively, the AUCR information may be stored (e.g., in the system store 122) and pulled by one or more computing devices 104 at regular times or in response to a user request. Whether pushed or pulled, the display device may be said to receive the AUCR information from the virtual assistant service 124. Examples of AUCR information generated by the virtual assistance service 124 are described below with reference to FIGS. 4-7. Although a watch is depicted as the device that displays the AUCR information, it will be understood that the watch is merely representative of any computing device capable of displaying information. Moreover, the virtual assistant service 124 may deliver the AUCR information to multiple devices associated with the user, not just a watch.

FIG. 4 is a schematic showing a display device 202 displaying an event reminder for an upcoming scheduled event in the form of a map of the user's vicinity with an arrow pointing a direction for the user 102 to follow to reach a location of the event. The arrow superimposed on the map serves as a discreet and glanceable reminder of the event. Other discreet and glanceable reminders are also contemplated and described herein. In one embodiment, the virtual assistant service 124 determines when to send the event reminder for display by examining scheduling information associated with the user 102 (accessible, e.g., from the system store 122), including a meeting time and location, if available, and the current location of the user 102 (available, e.g., via a GPS module on the user's mobile device and/or from the user's schedule).

For example, based on a travel time estimate, the virtual assistant service 124 determines a reminder lead time with which to provide the reminder to the user 102. The travel time estimate may be determined, for example, using a navigation service accessible to the virtual assistant service 124. The virtual assistant service 124 may also take weather and/or traffic conditions into account when determining the travel time estimate. For example, if the weather is predicted to be ill-suited for walking outdoors, the virtual assistant service 124 may access and take into account a bus or shuttle schedule in determining the travel time estimate. The weather and shuttle schedule information may be accessible, e.g., from a web address at which such information is known to be available. Moreover, the reminder lead time may be increased or decreased in dependence on traffic conditions.

In one embodiment, the virtual assistant service 124 may determine that a shuttle will likely be needed due to weather, travel distance, and/or user preferences, and may cause the display device 202 to display appropriate shuttle pick-up time and location information. For example, the virtual assistant service 124 may determine that a shuttle is needed for the user to arrive at the destination on time and/or to avoid bad weather (if the route would otherwise be walkable) and may therefore automatically request a shuttle. Accordingly, the virtual assistant service 124 may access and provide to the user 102 AUCR information that includes shuttle information, such as a shuttle number, a pick-up location, and/or an estimated time of arrival. If a shuttle request is possible, the virtual assistant service 124 may also automatically request a shuttle. In one example embodiment, the virtual assistant service 124 determines that a shuttle is likely to be needed if the travel time estimate is greater by a predetermined threshold amount than a remaining amount of time before a start time of the upcoming event. In addition, when the travel distance is short enough for walking, the virtual assistant service 124 may access a weather report and, if the weather is bad or predicted to become bad, the virtual assistant service 124 may suggest or automatically request a shuttle and cause appropriate shuttle information to be displayed to the user 102.

In addition to the map and arrow of FIG. 4, the AUCR information displayed on the display module 204 may include basic event information, such as the scheduled time, room number, and/or the subject of the event. If a change in event information has occurred since the initial scheduling of the event (e.g., a time change and/or room change), the virtual assistant service 124 may send AUCR information in a format that highlights the updated information to bring it to the user's attention.

In addition, in one embodiment, the virtual assistant service 124 automatically receives user location information on a continuous basis from the user's mobile device to facilitate regularly sending and displaying progressively more zoomed in maps as the user approaches the destination. As the user 102 enters the building at which the event is being held, the AUCR information may then be updated at the display device to include a map of the building interior with directions to a room in which the event is being held. The building map may also highlight the locations of various other places in the building, such as elevator banks, stairs, and/or restrooms. The virtual assistant service 124 may also access a list of event participants and/or one or more relevant documents and may send the participant list and/or documents to the display device 202 for display when the user is detected to be arriving or about to arrive at the event.

Alternatively, the initial reminder of the event may include an entire driving or walking route to be followed by the user. For example, if the travel distance is below a predetermined threshold, the entire route may be displayed at one time. Moreover, the device on which the AUCR information is displayed may be equipped to enable the user to zoom into or in other ways manipulate the view of the displayed route. Furthermore, once the user reaches the building, the virtual assistant service 124 may update the displayed information to include a building map, a list of event participants, and/or documents relevant to the event.

In one embodiment, the virtual assistant service 124 may determine an urgency level for the event reminder and may indicate an urgency level with a readily observable icon and/or a color scheme (e.g., red, yellow, green). The virtual assistant service 124 may cause the icon and/or color indication to be displayed after a map has already been displayed as an initial event reminder and the user appears to have missed or ignored it. The virtual assistant service 124 may determine that a user has likely missed a reminder by, for example, tracking the user's location. For example, the virtual assistant service 124 may determine that the user has missed the reminder if the user's location has not changed substantially within a predetermined window of time after the initial reminder.

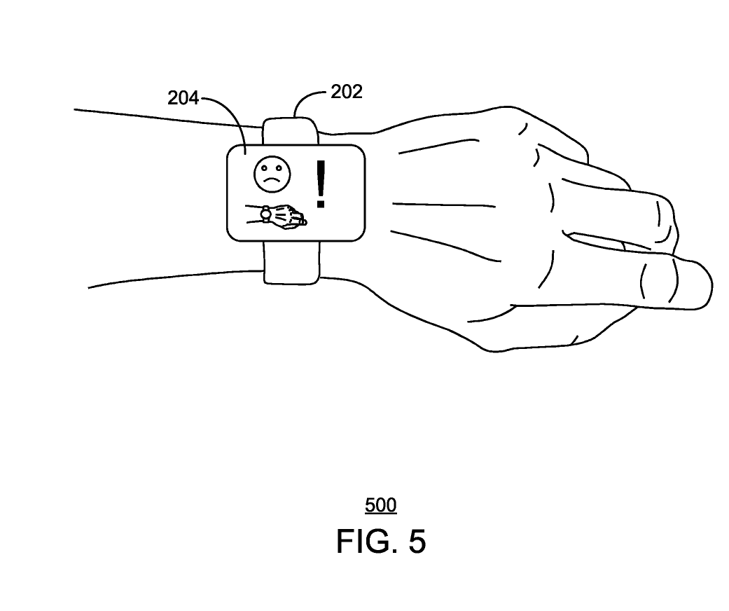

FIG. 5 is a schematic showing a display device 202 displaying an event reminder for an upcoming event in the form of an icon. As indicated above, an icon may be displayed after an initial event reminder in the form of a map has been displayed. Alternatively, the virtual assistant service 124 may cause the icon to be displayed as a sole or initial event reminder. The icon may be, for example, an image of a person looking at a watch with an exclamation point nearby (as depicted). However, the icon is not limited to this form. For example, the icon may simply be an exclamation point, e.g., to communicate urgency, or a calendar icon. Moreover, the icon may be displayed using different colors to communicate urgency. For example, the icon may initially be displayed using a first color (e.g., gray or green) and may subsequently be displayed using a second color (e.g., black or yellow) and finally a third color (e.g., red) as the window of time before the event start time gets progressively smaller.

In one embodiment, the virtual assistant service 124 sends AUCR information that includes an at least partially predefined message and a prompt to the user to approve transmission of the at least partially predefined message. For example, the virtual assistant service 124 may determine if a user is running late to an event based on a travel time estimate, the current time, and the event start time. If the user is determined to be running late, the virtual assistant service 124 can additionally estimate an amount of time by which the user is running late (e.g., by finding the difference between a current travel time estimate and the window of time remaining between the current time and the event start time) and can automatically compose a running late message with the running late amount of time. The virtual assistant service 124 can cause the running late message to be displayed to the user with a prompt for the user to quickly approve and send the message to one or more event participants, which are known to the virtual assistant service 124.

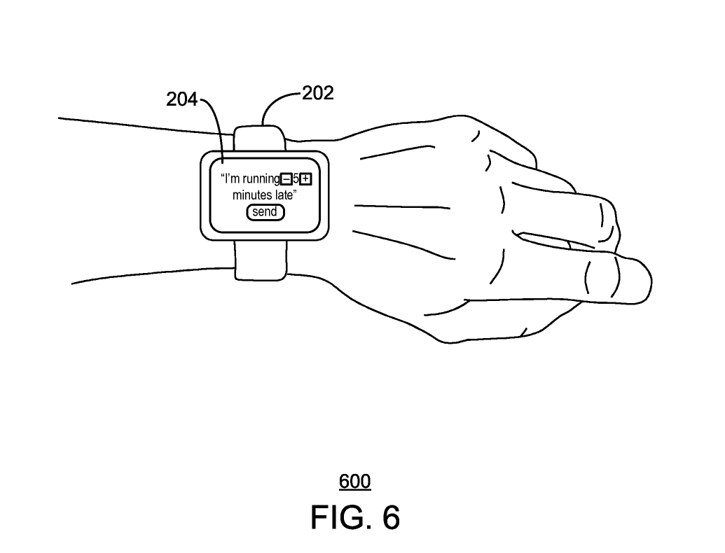

FIG. 6 is a schematic showing a display device 202 with a touch-screen display that is displaying an example running late message automatically generated by the virtual assistant service 124. The running late message includes a prompt for the user to send the message and optionally includes “+” and “−” icons to facilitate the manual modification of the amount of running late time before the message is sent.

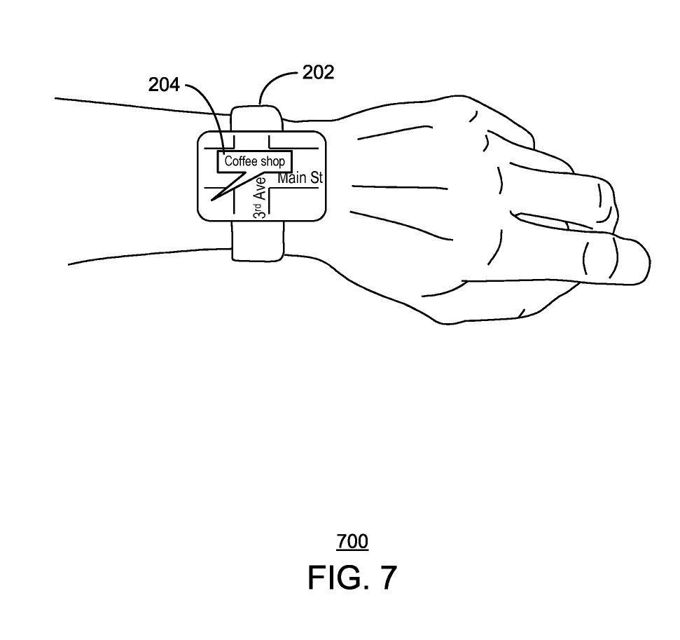

In addition to meeting reminders, the AUCR information may include information that is inferred from the user's routine activities and/or interests. FIG. 7 is a schematic showing a display device 202 displaying a coffee shop location as an example of this type of AUCR information. For example, the virtual assistant service 124 may log the user's location over the course of several days and, using machine learning techniques, may notice certain patterns of behavior. In addition or alternatively, the virtual assistant service 124 may learn user preferences by accessing a user profile. A user may, for example, take a routine coffee break at a certain time of day every day. The virtual assistant service 124 may have access to a map indicating that the location of the user at that time of day corresponds to the location of a coffee shop. Consequently, when the user is in a new locale, the virtual assistant service 124 may automatically retrieve the location of a nearby coffee shop and may cause this information to be displayed to the user, as shown in FIG. 7. However, if the user has a scheduled event that conflicts with the usual coffee break time, the virtual assistant service 124 may prioritize sending scheduled event reminders over the coffee shop location information.

A coffee break is one example of an inferred event. Another example of an inferred event is a lunch break. For example, when the user typically goes to lunch, the virtual assistant service 124 may cause the display device 202 to display a lunch menu and/or a camera feed that depicts a lunch line. Similarly, when a user typically leaves to or from work, the virtual assistant service 124 may cause the display device 202 to display traffic conditions at one or more points on the route to be travelled. In one embodiment, the virtual assistant service 124 may cause the display device 202 to display a weather report when the user wakes up and/or display a website that a user is tracking, such as a sports website during a break time.

In addition to providing the foregoing types of AUCR information, functions that improve the flow and effectiveness of meetings may also be performed by the virtual assistant service 124 and/or other services supported by the remote processing systems 118 (referred to herein as a “meeting service”). For example, the meeting service may provide to the display device 202 information relevant to a meeting, such as a list of meeting attendees or participants, introductory information related to each of a plurality of meeting attendees (e.g., a company position and/or a team or group affiliation), a status of each of the plurality of meeting attendees (e.g., running late, present, participating remotely, etc.). The status of an attendee may be received from the attendee or inferred from traffic, weather, and/or other external conditions. Moreover, if an attendee suddenly leaves the meeting and has left his/her phone, the status of the attendee may be indicated by the location of the nearest restroom.

The meeting service may also automatically keep track of meeting tasks (which may include, for example, displaying outstanding action items and associated information before and after the meeting) and may provide templates for specific types of appointments and/or email or text message responses, rank contacts (e.g., based on a log listing a time and/or location of communications with each of the contacts). In one embodiment, the meeting service automatically divvies up the time allotted for a meeting (or a portion of a meeting) to individual participants or agenda items and provides reminders to move on to a subsequent participant or agenda item. Thus, the AUCR information may include a set of prompts, each prompt in the set being provided at a preselected time during a meeting to reduce time overruns.

In one embodiment, the meeting service additionally facilitates operations that generally promote and improve the collaboration experience. Such operations can be particularly helpful for relatively long meetings and/or meetings with a large number of attendees. Example collaboration improvement operations performed by the meeting service include: allowing attendees to send messages to each other during a meeting, showing notes in a workspace from previous recurring meetings and corresponding documents, allowing attendees to share documents with an option to receive feedback on pages/slides, allowing attendees to share and edit notes collaboratively in real-time, allowing attendees to highlight and annotate objects in documents or notes, displaying notes/questions as they are written to remote attendees, receiving questions from and facilitating conversations with remote attendees without disturbing a presenter, playing back slides and/or meeting events in synchronization with notes, integrating documents and collaborative workspace with a collaborative workspace software solution, such as MICROSOFT OFFICE 365, importing to-do lists into a scheduling solution, such as MICROSOFT OUTLOOK, inviting non-attendees to participate on a focused topic, and allowing creation of custom polls—anonymous or non-anonymous—and logging poll results, e.g., to gauge audience comprehension of pages/slides or for other reasons. In one embodiment, the meeting service facilitates sending meeting information to a remote person (e.g., an attendee who is on their way to the meeting), to get an idea about what is transpiring or the information that has been disseminated so far. This allows the remote person to get up to speed quickly without disrupting the flow of the meeting. If the recipient has a display device capable of two-way communication, the meeting service may also facilitate the remote person giving feedback or answers.

Example collaboration improvement operations performed by the meeting service may also include: allowing attendees to provide real-time or near real-time feedback to a presenter, which may include, for example, allowing attendees to: propose questions for a presenter, vote for or otherwise indicate approval of proposed questions, vote to skip a presentation slide, indicate a need for more information relative to a presentation slide, and indicate a mood or emotion, such as interested, bored, stressed, sleeping, or the like. In one example embodiment, an indicated mood may be received by the meeting service from one or more of the meeting attendees. The meeting service may send the one or more mood indications to a display visible to all attendees, including the presenter(s), or, alternatively, the one or more mood indications may be sent only to the presenter(s).

In addition, after a meeting, the meeting service may show a shuttle booking interface if the user walks to a reception area and the interface may prompt the user to press a cancel button or the like to talk to a receptionist.

### B. Illustrative Processes

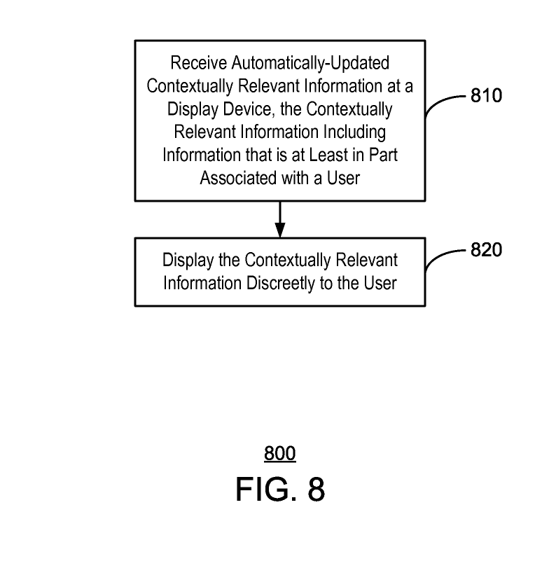

FIG. 8 is a schematic showing a process flow diagram 800 for a method implemented at a display device in accordance with the claimed subject matter. The method begins at block 810, where the display device receives automatically-updated contextually relevant (AUCR) information. The AUCR information includes information that is at least in part associated with a user. Then, at block 820, the display device displays the AUCR information to the user. As noted in the description of FIG. 2 above, the display device is a device having a display module (such as the watch depicted in FIG. 2, a HUD, a pair of glasses, a bracelet, a ring, or any other type of jewelry or wearable gear having a display module) that is capable of discreetly displaying information to the user. In addition, the user interface of the display device and format of the displayed information is glanceable or readily observable to facilitate discreet observation of the displayed information. The AUCR information is generated automatically by a service, such as the virtual assistant service 124 in FIG. 1, within an adaptively configurable window of time before an upcoming scheduled event and the AUCR information may serve as a reminder of the upcoming event. The AUCR information may also be generated automatically upon occurrence of, or in anticipation of the occurrence of, a user activity that the virtual assistant service has previously observed and learned. In this case, the AUCR information may include information that facilitates the user's ability to carry out the previously observed activity. Accordingly, a user can be apprised of information relevant to the context in which the user is situated in a timely manner without significant disruption to on-going activities.

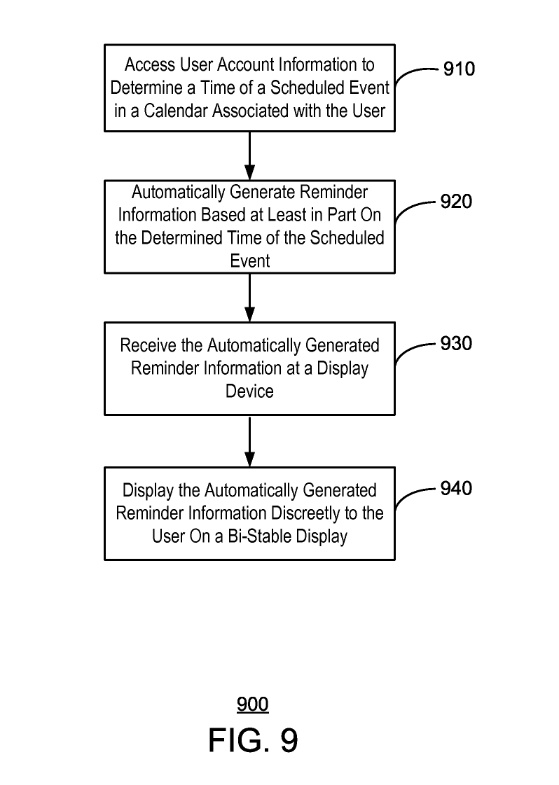

FIG. 9 is a schematic showing another process flow diagram 900 for a method implemented by a system comprising a virtual assistant service (e.g., virtual assistant service 124) and a display device (e.g., the display device 202) in accordance with the claimed subject matter. The method begins at block 910, where the virtual assistant service accesses user account information to determine a time of a scheduled event in a calendar associated with the user. Next, at block 920, the virtual assistant service automatically generates reminder information based at least in part on the determined time of the scheduled event. At block 930, the display device receives the automatically-generated reminder information and, at block 940, the display device displays the automatically-generated reminder information discreetly to the user on a bi-stable display.

The process flow diagrams 800 and 900 of FIGS. 8 and 9, respectively are provided by way of example and not limitation. More specifically, additional blocks or flow diagram stages may be added and/or at least one of the blocks or stages may be modified or omitted. For example, in one embodiment, various items of AUCR information may be generated and received by the display device and the display device may receive a series of instructions, each instruction identifying a different one of the items of AUCR information to be displayed. Such an embodiment may be useful in a scenario involving a sequence of steps needed to reach a location.

### C. Representative Computing Functionality

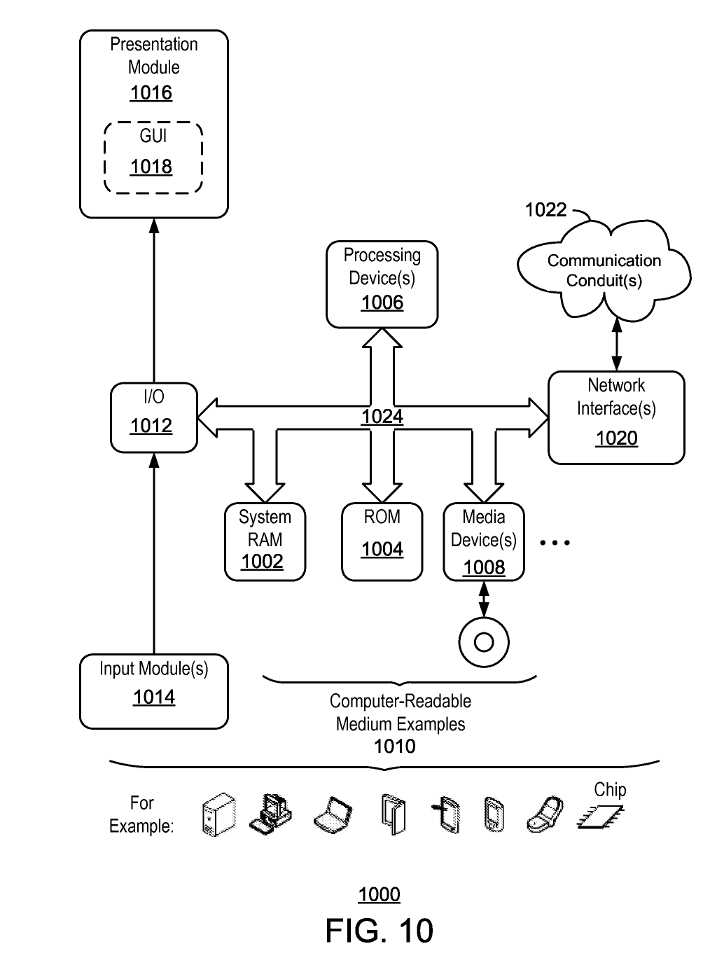

FIG. 10 is a schematic showing illustrative computing functionality 1000 that can be used to implement any aspect of the functions described above. For example, the computing functionality 1000 can be used to implement any aspect of the computing devices 104. In addition, the type of computing functionality 1000 shown in FIG. 10 can be used to implement any aspect of the remote processing systems 118. In one case, the computing functionality 1000 may correspond to any type of computing device that includes one or more processing devices. In all cases, the computing functionality 1000 represents one or more physical and tangible processing mechanisms.

The computing functionality 1000 can include volatile and non-volatile memory, such as RAM 1002 and ROM 1004, as well as one or more processing devices 1006 (e.g., one or more CPUs, and/or one or more GPUs, etc.). The computing functionality 1000 also may include various media devices 1008, such as a hard disk module, an optical disk module, and so forth. The computing functionality 1000 can perform various operations identified above when the processing device(s) 1006 executes instructions that are maintained by memory (e.g., RAM 1002, ROM 1004, or elsewhere).

More generally, instructions and other information can be stored on any computer readable medium 1010, including, but not limited to, static memory storage devices, magnetic storage devices, optical storage devices, and so on. The term computer readable medium also encompasses plural storage devices. In all cases, the computer readable medium 1010 represents some form of physical and tangible entity.

The computing functionality 1000 also includes an input/output module 1012 for receiving various inputs (via input modules 1014), and for providing various outputs (via output modules). One particular output mechanism may include a presentation module 1016 and an associated graphical user interface (GUI) 1018. The computing functionality 1000 can also include one or more network interfaces 1020 for exchanging data with other devices via one or more communication conduits 1022. One or more communication buses 1024 communicatively couple the above-described components together.

The communication conduit(s) 1022 can be implemented in any manner, e.g., by a local area network, a wide area network (e.g., the Internet), etc., or any combination thereof. The communication conduit(s) 1022 can include any combination of hardwired links, wireless links, routers, gateway functionality, name servers, etc., governed by any protocol or combination of protocols.

Alternatively, or in addition, any of the functions described in Sections A and B can be performed, at least in part, by one or more hardware logic components. For example, without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc.

Additionally, the functionality described herein can employ various mechanisms to ensure the privacy of user data maintained by the functionality. For example, the functionality can allow a user to expressly opt in to (and then expressly opt out of) the provisions of the functionality. The functionality can also provide suitable security mechanisms to ensure the privacy of the user data, such as, data-sanitizing mechanisms, encryption mechanisms, password-protection mechanisms, and so on.

Further, the description may have described various concepts in the context of illustrative challenges or problems. This manner of explanation does not constitute an admission that others have appreciated and/or articulated the challenges or problems in the manner specified herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method for receiving and displaying contextually relevant information to a user, the method comprising:
receiving automatically-updated contextually relevant information at a display device, the contextually relevant information including information that is at least in part associated with the user; and
displaying the contextually relevant information discreetly to the user.

2. The method recited in claim 1, wherein the contextually relevant information is displayed via a glanceable user interface.

3. The method recited in claim 1, wherein the contextually relevant information is displayed via a bi-stable display.

4. The method recited in claim 1, wherein various items of the contextually relevant information are displayed via readily observable icons.

5. The method recited in claim 1, wherein the contextually relevant information is derived from at least one of: a current time, an activity engaged in by the user, a current location of the user, and data stored in a user account.

6. The method recited in claim 5, wherein the contextually relevant information relates to a scheduled event.

7. The method recited in claim 5, wherein the contextually relevant information includes an at least partially predefined message and a prompt to the user to approve transmission of the at least partially predefined message.

8. The method recited in claim 1, wherein the contextually relevant information includes a set of prompts, each prompt in the set being provided at a preselected time during a meeting to reduce time overruns.

9. The method recited in claim 1, wherein the contextually relevant information includes a reminder to attend a meeting, the method further comprising:
receiving a mood indication from the user during the meeting; and
sending the received mood indication to a presenter at the meeting.

10. A display device for receiving and displaying contextually relevant information to a user, the display device comprising:
a display module;
a processing unit;
a system memory, wherein the system memory comprises code configured to direct the processing unit to:
receive contextually relevant information, the contextually relevant information including information that is automatically derived from at least a location of the user and schedule data associated with the user; and
cause the contextually relevant information to be displayed on the display module,
wherein the contextually relevant information is displayed to the user discreetly.

11. The display device recited in claim 10, wherein the contextually relevant information is displayed via a glanceable user interface.

12. The display device recited in claim 10, wherein the display module includes a bi-stable display module and the contextually relevant information is displayed via the bi-stable display module.

13. The display device recited in claim 10, wherein various items of the contextually relevant information are displayed via readily observable icons.

14. The display device recited in claim 10, wherein the contextually relevant information is derived from at least one of: a current time, a current location of the user, and data stored in a user account.

15. The display device recited in claim 14, wherein the contextually relevant information relates to a scheduled event.

16. The display device recited in claim 14, wherein the contextually relevant information includes an at least partially predefined message and a prompt to the user to approve transmission of the at least partially predefined message.

17. The display device recited in claim 10, wherein the display device is a wearable article.

18. The display device recited in claim 10, wherein the contextually relevant information includes a set of prompts, each prompt in the set being provided at a preselected time during a meeting to reduce time overruns.

19. The display device recited in claim 10, wherein the contextually relevant information includes a reminder to attend a meeting, and wherein the code is the system memory is further configured to direct the processing unit to receive a mood indication from the user during the meeting.

20. A method for displaying contextually relevant information to a user, the method comprising:
accessing user account information to determine a time of a scheduled event in a calendar associated with the user;
automatically generating reminder information based at least in part on the determined time of the scheduled event;
receiving the automatically-generated reminder information at a display device; and
displaying the automatically-generated reminder information discreetly to the user on a bi-stable display.
